(19) United States
(12) Patent Application Publication
(10) Pub. No.: US 2021/0166289 A1
(43) Pub. Date: Jun. 3, 2021

(54) PRODUCT RANKING SYSTEM TO IMPROVE EFFICIENCIES IN INTERACTING WITH E-COMMERCE PLATFORMS

(71) Applicant: SAP SE, Walldorf (DE)

(72) Inventor: Ahmad Hassan, Belfast (GB)

(21) Appl. No.: 16/701,341

(22) Filed: Dec. 3, 2019

(51) Int. Cl. G06Q 30/06; G06N 7/00

(52) U.S. Cl. CPC G06Q 30/0631; G06N 7/005

(57) ABSTRACT

Data for user interactions with products provided through a product catalog on a user interface of a web page is collected. The data for the user interactions is evaluated to determine events defined by at least one product from the products of the catalog, one or more properties of the at least one products, and user properties of a user from the users corresponding to the event. Rank values are determined for the events. A rank value defines a first probability for performing a purchase executed with a corresponding user interaction from the user interactions for a product from the catalog products performed by a first user from the users. Upon identifying user interactions from a user with the product catalog, a set of products from the products at the product catalog is determined to be provided for display based on the rank values and user properties of the user.

### BACKGROUND

Software platforms provide services and products to end customers. For example, e-commerce retail stores may provide services in relation to buying and selling products, such as clothes, household amenities, etc. Offered services and products through platforms may be directed to multiple target user groups. For example, an e-commerce system provides products in different marketing segments to different user categories to increase sales revenue. Online stores provide collections of products to different customer groups in different manner.

Software platforms, such as e-commerce platforms, can require a significant amount of technical resources to support. Example technical resources include computer processors, memory, and communication bandwidth. The manner in which users and the number of users that interact with an e-commerce platform can significantly effect the load on technical resources. For example, during periods of peak usage (e.g., Cyber Monday, Black Friday), the number of users interacting with an e-commerce platform can significantly increase, burdening the technical resources underlying the e-commerce platform, and, in some cases, even requiring additional technical resources to be brought on line. Further, interactions between a user and an e-commerce platform can be inefficient, further burdening the technical resources. For example, the more interactions a user requires with the e-commerce platform to achieve some end (e.g., identify and purchase an item), the more technical resources are expended.

### SUMMARY

Implementations of the present disclosure are directed to improving efficiencies in user interactions with e-commerce platforms based on identifying products for display at a product catalog presented at a user interface of a web page, where the products are directed to a particular user. More particularly, implementations of the present disclosure provide for determining rank values for purchasing events executed in relation to products provided through the product catalog. The rank values are determined products to be displayed at a product catalog on a user interface of a web page are determined. The identified products based on the rank values may be displayed to users interacting with the product catalog. Interactions performed by users with the product catalog may be evaluated and based on the rank values products may be determined to be correspondingly provided in different selections to different users. In this manner, a number of user interactions with the e-commerce platform is reduced, which reduces expenditure of technical resources underlying the e-commerce platform.

In some implementations, actions include collecting data for user interactions performed through a product catalog provided on a user interface of a web page, wherein the user interactions are performed by a plurality of users in relation to a plurality of products provided through the product catalog; evaluating the data for the user interactions to determine a plurality of events corresponding to the user interactions, wherein an event from the plurality of events is defined by at least one product from the plurality of products, one or more properties of the at least one products, and user properties of a user from the plurality of users corresponding to the event; determining a plurality of rank values corresponding to the plurality of events, wherein a first rank value from the plurality of rank values define a first probability for performing a purchase executed with a corresponding user interaction from the user interactions for a product from the plurality of products performed by a first user from the plurality of users; and upon identifying user interactions from a second user with the product catalog, determining a set of products from the plurality of products at the product catalog to be provided for display, wherein the set of products are determined based on the plurality of rank values and user properties of the second user.

Other implementations of this aspect include corresponding systems, apparatus, and computer programs, configured to perform the actions of the methods, encoded on computer storage devices.

These and other implementations can each optionally include one or more of the following features: the user interactions are associated with purchase transactions and with viewing interactions for one or more products from the product catalog.

In some instances, determining the plurality of rank values includes determining a first set of mutually exclusive events from the plurality of events and a second set of non-mutually exclusive events from the plurality of events; determining a first set of rank values corresponding to the first set of mutually exclusive events; and determining a second set of rank values corresponding to the second set of non-mutually exclusive event. A rank value from the first set of rank values is determined as a sum of probabilities of purchasing products part of a corresponding event from the first set of mutually exclusive events. A rank value from the second set of rank values is determined for an event defining a first set of products from the plurality of products, wherein the rank value is determined as a result of subtracting a probability of purchasing the first set of products as a group from a sum of probabilities of buying each of the first set of products.

In some instances, the plurality of rank values include a first set of rank values corresponding to events that are mutually exclusive and a second set of rank values corresponding to events that are non-mutually exclusive.

In some instances, a first event and a second event from the plurality of events are mutually exclusive when a first product associated with the first event is an alternative to a second product associated with the second event.

In some instance, the set of products is determined by comparing the user properties of the second user and user properties associated with the plurality of events corresponding to the plurality of rank values.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture that can be used to execute implementations related to product purchase ranking and recommendation in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to identifying products to be provided for display at a product catalog for a particular user currently interacting with the product catalog. More particularly, implementations of the present disclosure are directed to determining rank values for purchasing events executed in relation to products provided through the product catalog. Implementations can include actions of collecting data for user interactions performed through a product catalog provided on a user interface of a web page, wherein the user interactions are performed by a plurality of users in relation to a plurality of products provided through the product catalog; evaluating the data for the user interactions to determine a plurality of events corresponding to the user interactions, wherein an event from the plurality of events is defined by at least one product from the plurality of products, one or more properties of the at least one products, and user properties of a user from the plurality of users corresponding to the event; determining a plurality of rank values corresponding to the plurality of events, wherein a first rank value from the plurality of rank values define a first probability for performing a purchase executed with a corresponding user interaction from the user interactions for a product from the plurality of products performed by a first user from the plurality of users; and upon identifying user interactions from a second user with the product catalog, determining a set of products from the plurality of products at the product catalog to be provided for display, wherein the set of products are determined based on the plurality of rank values and user properties of the second user.

Software platforms provide different content including different selections of products to target different users and address different customer behavior thus to increase sales revenue. Products suggested to customers on a user interface of a product catalog presented on a web page may be determined based on evaluation of customer behavior and collected historical data for performed purchasing or viewing events in relation to products provided through the product catalog. Purchases of products are performed in groups or as single entities. Some products are mutually exclusive as alternative version or incompatible options. Some products may be non-exclusive and with high probability of purchasing as a set with some other products, e.g. main product and accessories. Purchase events can be evaluated and probabilities of buying a product from a new customer based on tracking his interaction with the product catalog and/or his user properties (profile) may be determined. Based on such determined probabilities of purchasing products from the product catalog, a selection of products to be loaded at the user interface view for that new customer may be defined to correspond to product items of interest to that new customer.

Implementations of the present disclosure improve efficiency of interaction between human users and e-commerce platforms. User interactions with e-commerce platforms can be inefficient, which burdens the underlying computing resources (e.g., processors, memory). This can be of particular concern during peak times of higher purchase load, such as events like Cyber Monday, Christmas period, etc. Inefficient use of computing resources also results in slower communication with the e-commerce platform, which may result in delayed presentation of information on the user interface. That can require additional resources to have to be brought online for maintaining

In some instances, ranking products based on associations, user interest and similarity are problems addressed in the modern e-commerce world. When a user searches for a product with some custom text, then the relevant results may be ranked based on their associations, user personal taste and historical trend. User behavior may be captured based on executed purchases through a product catalog. Products may be ranked based on evaluated user behavior in relation to purchases. When the products are ranked, some products may be selected for potential marketing promotions to particular customer who ends up buying some or all of those top ranked products. By providing each to reach content in relation to products that are with higher probability of purchasing, business sales transactions executed through the web page may be increased, customer experience with the product catalog can be improved, and operations of the web page and the resources expended for running and maintaining the product catalog may be efficiently allocated. By provided more relevant content to users, the number of user interactions may be diminished and thus operations may be improved.

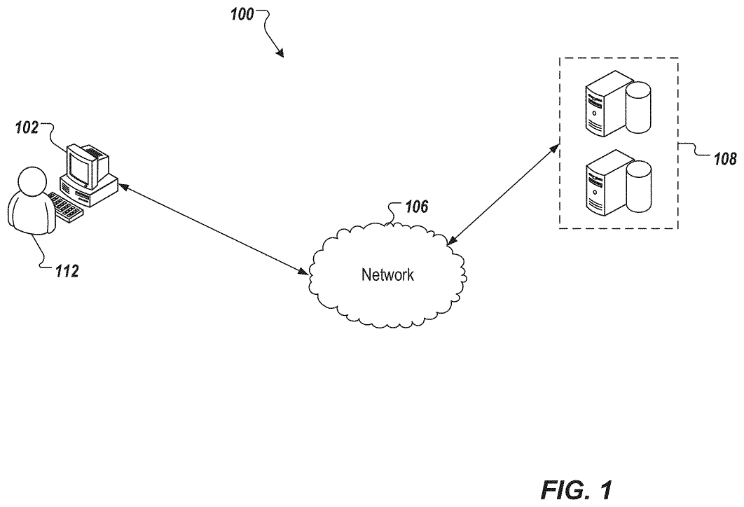

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host an application (e.g., provided as one or more computer-executable programs executed by one or more computing devices) that provides services in relation to products to end users. In some instances, the application is a web page displaying a product catalog where customers may preview and execute purchases of products of different categories and with different properties. Such a web portal, may be an e-commerce online store for clothes, shoes, computer equipment, etc.

The web page provides a user interface where a selection of products offered by the product catalog may be presented. Users such as customer may interact with the displayed content in relation to one or more of the products and may execute purchases. The user interface may include different tools and interaction controls to navigate between different product categories and select products of certain type and of certain properties.

In some instances, a set of products may be selected to be provided at a display area of a user interface screen currently in view of a customer of the product catalog. The provided set of products for display may be targeted to the profile of the customer. Further, the provided set of products may be determined based on information about the customer, such as customer behavior and interaction with the product catalog. Further, the provided set of products may be determined based on implemented evaluation logic that evaluates interactions performed through the product catalog at the web page. Evaluation of such interaction data may be performed to determine rank values of purchasing events for different products.

In some instances, based on evaluation of data for user interactions for multiple products provided through a product catalog by multiple users, probabilities of performing a purchase in relation to a product may be determined. Further, a product catalog may offer some products where purchasing them at the same time may be classified as a mutually exclusive event. For example, mutually exclusive events may be a purchase of a T-shirt of size S and a purchase of a T-shirt of size XL. Also, at the product catalog there may be products that are not mutually exclusive. For example, they may be complementary products, such as hats and gloves. Based on evaluation of different events of purchasing and their relations of execution in a single or multi-purchase scenario, purchasing events for the products from the product catalog may be ranked. Based on such ranking, sets of products may be identified for different users based on their interactions with the product catalog.

In some instances, a group of products provided through a product catalog can be interlinked by the type of products, accessories of parent product or customer pattern of buying similar products together. For example, a person buying bread online is most probably be buying the egg and/or jam as well. There is no explicit relationship between such product associations, but these kinds of relationships can be derived implicitly based on the user buying pattern and the products being sold within the same cart defined for purchasing products from the product catalog. in a given user session.

According to additional law of probability, if two events are mutually exclusive then the probability that at least one of the events occurs is the sum of individual probabilities of the two events. For example, if two products p1 and p2 have been available, then the probability of p1 or p2 to be selected is defined as in equation (1) below:

P(p1 or p1)=P(p1)+P(p2) (1)

If two events are non-mutually exclusive purchase events, meaning that two product may be bought at the same time, then the probability of p1 and p2 to be selected is defined as in equation (2) below:

P(A1+A2)=P(A1)+P(A2)−P(A1∩A2) (2)

In some instances, based on evaluation of different events occurring at a web page in relation to purchases of products from a product catalog, the products may be ranked and the determined ranking may be utilized for identifying distribution of products for different users or different user groups. Such evaluation of ranking of products may be performed dynamically when a new customer has started interacting with products provided through the product catalog on the web page.

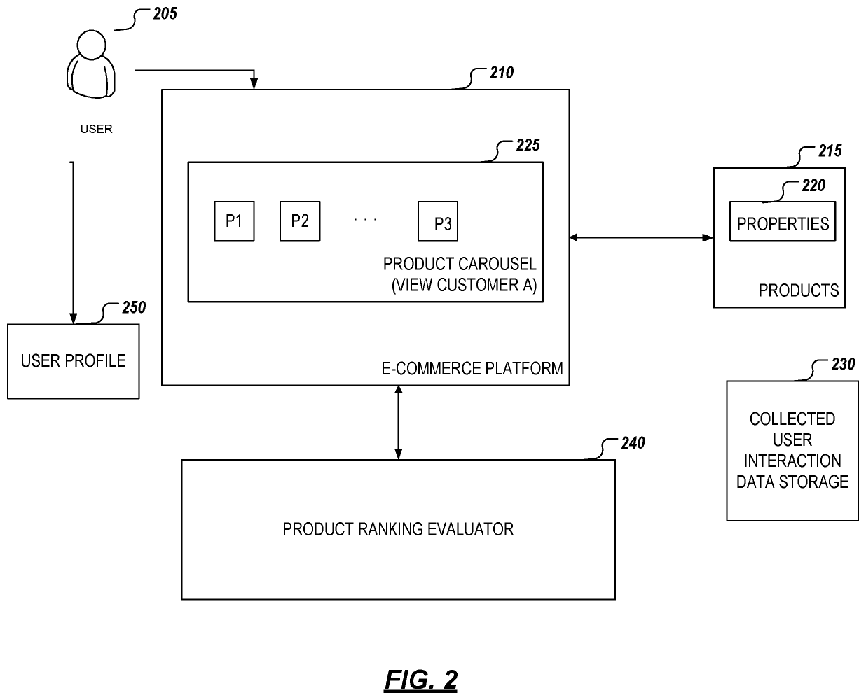

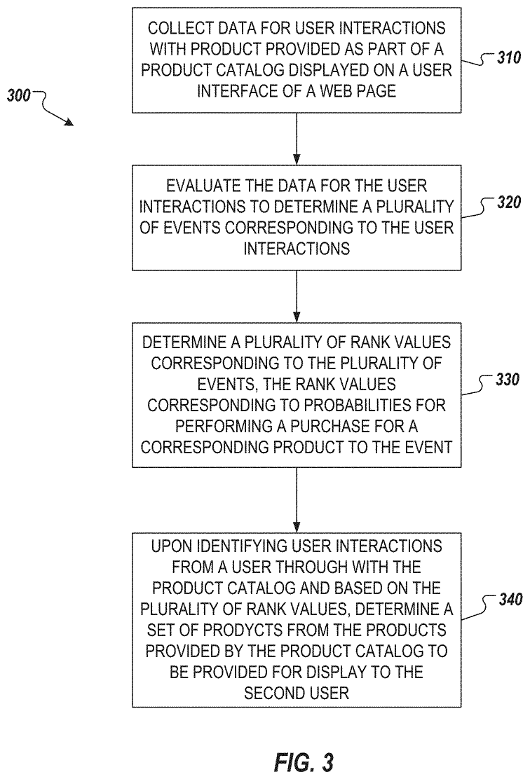

In some instances, a user of the product catalog may be a customer who goes to a products carousel presented on a display area of the user interface of the web page. The product carousel may include a selection of products from the products at the product catalog that are targeted to the customer, for example, based on his preferences or user profile. For example, the customer may be viewing some of the products and may be selecting one or more of them for buying, for example, by adding them to a shopping cart. At a subsequent time, when the same customer logs into the product catalog, the products shown within the carousel displayed on the user interface may be selected based on ranking of products in relation to history of his interaction events, for example, selection, viewing, purchasing, etc. The ranking of the products and the identification of products to be presented at the product carousel may be such as those described below in relation to FIGS. 2 and 3.

FIG. 2 depicts an example architecture 200 that can be used to execute implementations related to product purchase ranking and recommendation in accordance with implementations of the present disclosure.

In some instances, users 205 interact with an e-commerce platform 210. The e-commerce platform may be an on-premise platform or a cloud platform running at a hosted infrastructure and serving clients' requests in relation to a product catalog defined in relation to products 215. The e-commerce platform 210 may be displayed at a web page and provide different user interfaces in relation to different services provided for the product catalog, such as, product previewing, selection for purchasing, execution of sales transactions, preference configurations, product comparison, etc.

In some instances, the interactions of users 205 may be collected at collected user interaction data storage 230. The collected data includes different interactions performed by different users having different user profiles 250.

In some instances, the e-commerce platform 210 may display a web page view including a product carousel 225. The product carousel may include a selection of products from the products 215. The selected products, such as, p1, p2, and p3, may be determined based on a particular user from the users 205 who is interacting with the e-commerce platform.

In some instances, the e-commerce platform 210 is communicatively coupled to a product ranking evaluator 240. The product ranking evaluator 240 is implemented to evaluated collected user interaction data, such as the data from the collected user interaction storage 230. The product ranking evaluator 240 is configured to evaluate the data for user interactions performed at the e-commerce platform 210 and to determine a plurality of events corresponding to the user interactions. The determined events are defined at least in relation to one product from the multiple products 215 associated with the e-commerce platform. The events may be associated with products having particular properties 220. The properties defined for the products may vary based on a product type of category. For example, clothes may have a set of properties, such as size and color. An event associated with one or more of the product may also be associated with a quantity of the particular one or more products being bought. The event may also be associated with a user profile of a user from the plurality of users corresponding to the event.

In some instances, based on the implemented evaluation logic at the product ranking evaluator 240, a plurality of rank values corresponding to the determined events are determined. The determination of the ranks in relation to different events, such as mutually exclusive or non-mutually exclusive events may be performed as discussed above or as discussed in relation to FIG. 3 and provided examples below.

In some instances, when a user logs onto the e-commerce platform 210, the e-commerce platform 210 may intercept the interactions of the user with some of the products 215 and determine the user profile, and communicate that received interaction data to the product ranking evaluator 240. Upon receiving the data at the product ranking evaluator, a set of products from the products 215 at the product catalog to be provided for display at the e-commerce platform 210 are determined. The determination is based on the computed rank values for purchasing events for the products from the products 215 and based on the user profile of the user interacting with the e-commerce platform.

In some instances, the product ranking evaluator 240 may be implemented as a module that is part of the e-commerce platform 210.

In some instances, the e-commerce platform may be an e-commerce store having multiple products including product P1, P2, and P3. For example, the following three products in the catalog are with respective quantity—P1=10 ITEMS; P2=20 ITEMS; and P3=15 ITEMS. For the same of the example, the total catalog size is 100 products. Let A1 is the event that shows visit of a customer who purchases a product P1 (i.e. soup) and buy a quantity of 2. A1 shows the sale of product P1. Then the probability after the first purchase will be as described in equation (3):

$$P ( A 1 ) = \frac{{C}_{10}^{2}}{{C}_{100}^{2}} = 45 / 4950 = 0.009 \qquad ( 3 )$$

The probability of the first purchase is computer as a combination probability, that is computed according to equation (4):

$$C ( n , r ) = \frac{P ( n , r )}{r !} \qquad ( 4 )$$

where n is the distinct objects corresponding to products from the product catalog. The granularity of definition of products may be in relation to product category, or product property level, or combination thereof.

Here 10 is the stock available for Product P1 and 100 is the total stock of all the products. The equation (3) shows that 2 products have been picked up from the Product P1 total stock which is 10 (i.e. combination of 2 out of 10), and as a result 2 products are picked from the total stock available which was 100 products. The equation (3) gives the probability if only product P1 is picked up from the total catalog of products.

Let A2 is the event that shows visit of the same customer who purchases a product P1 (i.e. soup) with quantity of 3 and product P2 (i.e. shampoo) with a quantity of 5. Then the probability after the second purchase will be according to equation (5):

P(A2)=(C(10,3))*(C(20,5))/(C(100,8)) (5)

The equation (5) gives the probability if only this event happened and product

P1 and P2 were purchased. The equation (5) assumes that the event in equation (3) has never happened. Subsequently, a joint probability of equation (3) and (5) can be calculated, if both occur. Here 10 is the stock available for Product P1 and 100 is the total stock of all the products. The equation (5) shows that 3 products have been picked up from the product P1 total stock which is 10 (i.e., C (10, 3)), and 5 products p2 have been purchased from 20 p2 products stock. As a result 8, products are picked from the total stock available which was 100 products (i.e., C(100,8)). Equation (5) gives the probability if only A2 event has happened.

The joint probability of the two purchases may be defined according to equation (6) below:

P(A1∩A2)=P(A1)*P(A2) (6)

As A1 and A2 are non-mutually exclusive events, the joint probability is calculated as P(A1∩A2)=(C(10, 2)/C (100, 2)*((C(8,3)*C(20,5))/(C(98, 8)).

In equation (3) and (5), it is assumed that either A1 has happened or A2 has happened. However in above equation, the joint probability of P(A1∩A2) is calculated, which shows that both has happened. Now in this case, first A1 has happened, which includes buying 2 P1 products from the stock size of 10 and which results in 2 products being picked from total available catalog of 100. The result of this is C(10, 2)/C (100, 2).

For the second event A2, because the A1 event has now happened, the remaining P1 products are 8 out of 10. Consequently, in A2, the user buying 3 P1 products from the total stock of remaining 8 P1 products and 5 P2 products from the P2 stock of 20 products. Because 2 products have already been bought by A1 event, that is why the remaining total products are 98. That is why (C(98,8)) is provided as a denominator which shows that in case of joint probability, A2 event buys 8 products from the total catalog of 98. As a result, the total joint probability is determined as P(A1 A2)=(C(10, 2)/C (100, 2)*((C(8,3)*C(20,5))/(C(98, 8)).

Total probability is P(A1+A2)=P(A1)+P(A2)−P(A1∩A2).

Total probability of first visit A1 and second visit A2 is defined at equation (7) below:

C(10,2)/C(100,2)+(C(10,3))*(C(20,5))/(C(100,8))−(C(10,2)/C(100,2)*((C(8,3)*C(20,5))/(C(98,8)) (7)

Actual probability of second purchase A2 is equation (7)-equation (5).

The equations (3) and (7) can be compared for ranks. Let A3 be the event that shows visit of the customer who purchases a product P2 (i.e., shampoo) with a quantity of 5 and product P3 (i.e. cream) with quantity of 6.

P(A3)=(C(20,5)*C(15,6))/C(100,11)

The joint probability P(A1∩A2) can be calculated as P(A1∩A2)=P(A1)*P(A2|A1). Therefore, P(A1∩A2)=(C(10, 2)/C(100, 2))*(C(8,3)*C(20,5))/C(98,8).

The joint probability P(A1∩A2) can be calculated as P(A1∩A3)=P(A1)*P(A1|A3). Then, P(A1∩A3)=((C(10, 2)/C(100,2)*(C(20, 5)*C(15, 6))/C(98, 11).

The joint probability P(A2∩A3) can be calculated as

P(A2∩A3)=P(A2)*P(A2|A3)

Then, P(A2∩A3) equals the equation (8) below:

P(A2∩A3)=((C(10,3)*C(20,5)/(C(100,8))*(C(15,5)*C(15,6)/C(92,11). (8)

Total probability for 3 visits A1 A2 and A3 is according to equation (9):

P(A1+A2+A3)=P(A1)+P(A2)+P(A3)−P(A1∩A2)−P(A1∩A3)−P(A2∩A3)==C(10,2)/C(100,2)+C(10,2)/C(100,2)+(C(10,3))*(C(20,5))/(C(100,8))−(C(10,2)/C(100,2)*((C(8,3)*C(20,5))/(C(98,8))−((C(10,3)*C(20,5)/(C(100,8))*(C(15,5)*C(15,6)/C(92,11). (9)

Actual probability of third purchase A2 is equation (9) minus equation (7).

FIG. 3 depicts an example process 300 that can be executed in accordance with implementations of the present disclosure. In some examples, the example process 300 is provided using one or more computer-executable programs executed by one or more computing devices.

At 310, data for user interactions performed through a product catalog provided on a user interface of a web page is collected. The product catalog may include different products, such as the products 215, FIG. 2. The product catalog may be provided on a user interface of an e-commerce platform, such as the e-commerce platform 210, FIG. 2. The user interactions are performed by a plurality of users in relation to a plurality of products provided through the product catalog. In some instances, the collected data is stored at a data storage, such as the collected user interaction data storage 230, FIG. 2.

In some instances, the user interactions are associated with purchase transactions and with viewing interactions for one or more products from the product catalog.

At 320, the collected data for the user interactions is evaluated. A plurality of events corresponding to the user interactions are determined. An event from the plurality of events is defined by at least one product from the plurality of products, one or more properties of the at least one products, and a user profile of a user from the plurality of users corresponding to the event. For example, an event for purchasing product A may be defined by the product such as a T-shirt, by properties such as size, color and quantity—e.g. size S, red color and 1 piece, and by information about the user who performed the purchase—e.g., user located in London, UK and a female.

At 330, a plurality of rank values corresponding to the plurality of events are determined. A rank value defines a probability for performing a purchase executed with a corresponding user interaction from the user interactions from the collected data. The executed purchase is for a product from the plurality of products provided through the product catalog. The purchase is performed by a first user from the plurality of users interacting with the product catalog.

In some instances, determining the rank values includes determining a first set of mutually exclusive events from the plurality of events and a second set of non-mutually exclusive events from the plurality of events. A first set of rank values corresponding to the first set of mutually exclusive events may be determined. A rank value from the first set of rank values is determined as a sum of probabilities of purchasing products part of a corresponding event from the first set of mutually exclusive events.

For example, a first event and a second event from the plurality of events are mutually exclusive when a first product associated with the first event is an alternative to a second product associated with the second event.

Further, a second set of rank values corresponding to the second set of non-mutually exclusive event may also be determined. A rank value from the second set of rank values is determined for an event defining a first set of products from the plurality of products. The rank value is determined as a result of subtracting a probability of purchasing the first set of products as a group from a sum of probabilities of buying each of the first set of products.

At 340, user interactions from a second user with the product catalog is identified. For example, the second user selected one pair of jeans of size S. based on the identified interaction of the second user, a set of products from the plurality of products at the product catalog is determined to be provided for display to the second user. The set of products are determined based on determined rank values, at 330, and a user profile of the second user.

In some instances, the set of products that are determined to be provided for display to the second user are determined by comparing the user profile of the second user and user profiles associated with the plurality of events corresponding to the plurality of rank values.

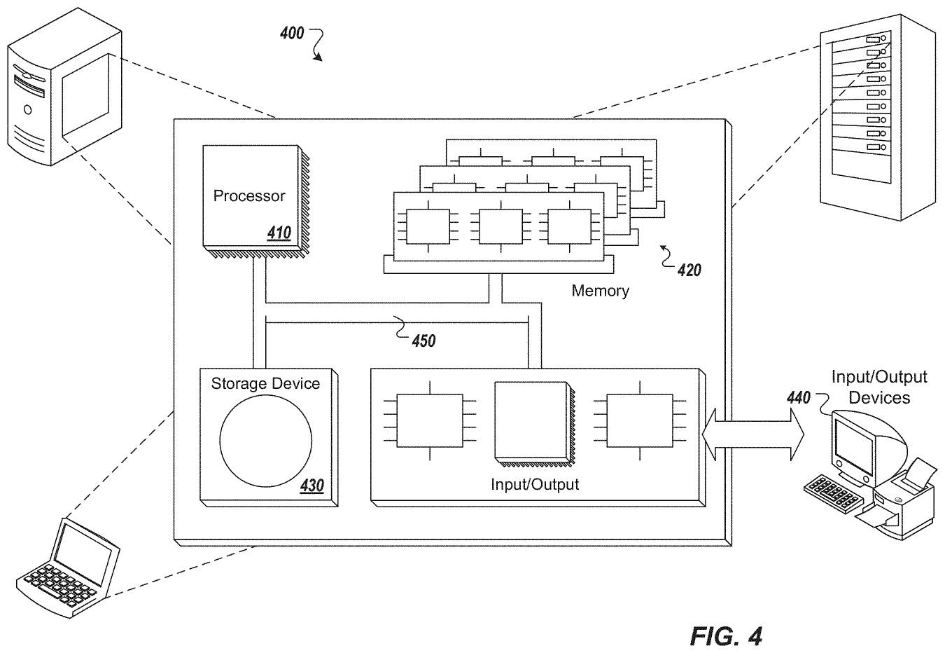

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method, the method being executed by one or more processors and comprising:
collecting data for user interactions performed through a product catalog provided on a user interface of a web page, wherein the user interactions are performed by a plurality of users in relation to a plurality of products provided through the product catalog;
evaluating the data for the user interactions to determine a plurality of events corresponding to the user interactions, wherein an event from the plurality of events is defined by at least one product from the plurality of products, one or more properties of the at least one products, and user properties of a user from the plurality of users corresponding to the event;
determining a plurality of rank values corresponding to the plurality of events, wherein a first rank value from the plurality of rank values define a first probability for performing a purchase executed with a corresponding user interaction from the user interactions for a product from the plurality of products performed by a first user from the plurality of users; and
upon identifying user interactions from a second user with the product catalog, determining a set of products from the plurality of products at the product catalog to be provided for display, wherein the set of products are determined based on the plurality of rank values and user properties of the second user.

2. The method of claim 1, wherein the user interactions are associated with purchase transactions and with viewing interactions for one or more products from the product catalog.

3. The method of claim 1, wherein determining the plurality of rank values comprises:
determining a first set of mutually exclusive events from the plurality of events and a second set of non-mutually exclusive events from the plurality of events;
determining a first set of rank values corresponding to the first set of mutually exclusive events; and
determining a second set of rank values corresponding to the second set of non-mutually exclusive event.

4. The method of claim 3, wherein a rank value from the first set of rank values is determined as a sum of probabilities of purchasing products part of a corresponding event from the first set of mutually exclusive events.

5. The method of claim 3, wherein a rank value from the second set of rank values is determined for an event defining a first set of products from the plurality of products, wherein the rank value is determined as a result of subtracting a probability of purchasing the first set of products as a group from a sum of probabilities of buying each of the first set of products.

6. The method of claim 1, wherein the plurality of rank values comprise a first set of rank values corresponding to events that are mutually exclusive and a second set of rank values corresponding to events that are non-mutually exclusive.

7. The method of claim 1, wherein a first event and a second event from the plurality of events are mutually exclusive when a first product associated with the first event is an alternative to a second product associated with the second event

8. The method of claim 1, wherein the set of products is determined by comparing the user properties of the second user and user properties associated with the plurality of events corresponding to the plurality of rank values.

9. A non-transitory computer-readable storage medium coupled to one or more processors and having instructions stored thereon which, when executed by the one or more processors, cause the one or more processors to perform operations, the operations comprising:
collecting data for user interactions performed through a product catalog provided on a user interface of a web page, wherein the user interactions are performed by a plurality of users in relation to a plurality of products provided through the product catalog;
evaluating the data for the user interactions to determine a plurality of events corresponding to the user interactions, wherein an event from the plurality of events is defined by at least one product from the plurality of products, one or more properties of the at least one products, and user properties of a user from the plurality of users corresponding to the event;
determining a plurality of rank values corresponding to the plurality of events, wherein a first rank value from the plurality of rank values define a first probability for performing a purchase executed with a corresponding user interaction from the user interactions for a product from the plurality of products performed by a first user from the plurality of users; and
upon identifying user interactions from a second user with the product catalog, determining a set of products from the plurality of products at the product catalog to be provided for display, wherein the set of products are determined based on the plurality of rank values and user properties of the second user.

10. The computer-readable medium of claim 9, wherein the user interactions are associated with purchase transactions and with viewing interactions for one or more products from the product catalog.

11. The computer-readable medium of claim 9, wherein determining the plurality of rank values comprises:
determining a first set of mutually exclusive events from the plurality of events and a second set of non-mutually exclusive events from the plurality of events;
determining a first set of rank values corresponding to the first set of mutually exclusive events; and
determining a second set of rank values corresponding to the second set of non-mutually exclusive event,
wherein a rank value from the first set of rank values is determined as a sum of probabilities of purchasing products part of a corresponding event from the first set of mutually exclusive events, and
wherein a rank value from the second set of rank values is determined for an event defining a first set of products from the plurality of products, wherein the rank value is determined as a result of subtracting a probability of purchasing the first set of products as a group from a sum of probabilities of buying each of the first set of products.

12. The computer-readable medium of claim 9, wherein the plurality of rank values comprise a first set of rank values corresponding to events that are mutually exclusive and a second set of rank values corresponding to events that are non-mutually exclusive.

13. The computer-readable medium of claim 9, wherein a first event and a second event from the plurality of events are mutually exclusive when a first product associated with the first event is an alternative to a second product associated with the second event

14. The computer-readable medium of claim 9, wherein the set of products is determined by comparing the user properties of the second user and user properties associated with the plurality of events corresponding to the plurality of rank values.

15. A system, comprising:
a computing device; and
a computer-readable storage device coupled to the computing device and having instructions stored thereon which, when executed by the computing device, cause the computing device to perform operations, the operations comprising:
collecting data for user interactions performed through a product catalog provided on a user interface of a web page, wherein the user interactions are performed by a plurality of users in relation to a plurality of products provided through the product catalog;
evaluating the data for the user interactions to determine a plurality of events corresponding to the user interactions, wherein an event from the plurality of events is defined by at least one product from the plurality of products, one or more properties of the at least one products, and user properties of a user from the plurality of users corresponding to the event;
determining a plurality of rank values corresponding to the plurality of events, wherein a first rank value from the plurality of rank values define a first probability for performing a purchase executed with a corresponding user interaction from the user interactions for a product from the plurality of products performed by a first user from the plurality of users; and
upon identifying user interactions from a second user with the product catalog, determining a set of products from the plurality of products at the product catalog to be provided for display, wherein the set of products are determined based on the plurality of rank values and user properties of the second user.

16. The system of claim 15, wherein the user interactions are associated with purchase transactions and with viewing interactions for one or more products from the product catalog.

17. The system of claim 15, wherein determining the plurality of rank values comprises:
determining a first set of mutually exclusive events from the plurality of events and a second set of non-mutually exclusive events from the plurality of events;
determining a first set of rank values corresponding to the first set of mutually exclusive events; and
determining a second set of rank values corresponding to the second set of non-mutually exclusive event,
wherein a rank value from the first set of rank values is determined as a sum of probabilities of purchasing products part of a corresponding event from the first set of mutually exclusive events, and
wherein a rank value from the second set of rank values is determined for an event defining a first set of products from the plurality of products, wherein the rank value is determined as a result of subtracting a probability of purchasing the first set of products as a group from a sum of probabilities of buying each of the first set of products.

18. The system of claim 15, wherein the plurality of rank values comprise a first set of rank values corresponding to events that are mutually exclusive and a second set of rank values corresponding to events that are non-mutually exclusive.

19. The system of claim 15, wherein a first event and a second event from the plurality of events are mutually exclusive when a first product associated with the first event is an alternative to a second product associated with the second event

20. The system of claim 15, wherein the set of products is determined by comparing the user properties of the second user and user properties associated with the plurality of events corresponding to the plurality of rank values.
